(19) United States
(12) Patent Application Publication
(10) Pub. No.: US 2011/0085519 A1
(43) Pub. Date: Apr. 14, 2011

(54) Spreading Code Allocation

(75) Inventors: Tommi T. Koivisto, Espoo (FI); Marko Karl Juhani Lampinen, Oulu (FI); Mihai Enescu, Espoo (FI); Timo E. Roman, Espoo (FI)

(73) Assignee: Nokia Corporation

(21) Appl. No.: 12/576,299

(22) Filed: Oct. 9, 2009

(51) Int. Cl. H04B 7/216

(52) U.S. Cl. 370/335

(57) ABSTRACT

A method includes allocating length-2n spreading codes to reference signals contained on first and second groups of resource elements in a first physical resource block and to copies of the reference signals contained on a selected group from the first or second groups and a third group of resource elements in a second physical resource block. Each length-2n spreading code is determined using a first length-n spreading code allocated to the first group and a second length-n code allocated to the second group, or using whichever one of the first or second length-n spreading codes is allocated to the selected group and a third length-n spreading code allocated to the third group. Symbols for the reference signals and their copies are spread and transmitted on the first and second physical resource blocks.

### TECHNICAL FIELD

The exemplary and non-limiting embodiments of this invention relate generally to wireless communication systems, methods, apparatus/devices and computer programs and, more specifically, relate to spreading codes used to spread symbols for resource elements.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
CDM code division multiplexing
DL downlink (eNB towards UE)
DM-RS demodulation RS
DRS dedicated reference signal
DwPTS downlink part of the special subframe
eNB EUTRAN Node B (evolved Node B, base station/access node)
EPC evolved packet core
EUTRAN evolved UTRAN (LTE)
FDM frequency division multiplexing
GP guard period
IP internet protocol
LTE long term evolution
LTE-A LTE-advanced
MAC medium access control
MIMO multiple input multiple output
MU multi user
MM/MME mobility management/mobility management entity
NACK not acknowledge/negative acknowledge
O&M operations and maintenance
OFDMA orthogonal frequency division multiple access
OVSF orthogonal variable spreading factor
PHY physical
PDCP packet data convergence protocol
PRB physical resource block
RB radio bearer
RE resource element
Rel release
RLC radio link control
RS reference signal
SC FDMA single carrier, frequency division multiple access
SU single user
TDD time division duplex
TS technical standard
UE user equipment
UL uplink (UE towards eNB)
UpPTS uplink part of the special subframe
URS UE specific reference signals, also called user specific reference signals
UTRAN universal terrestrial radio access network

The specification of a communication system known as evolved UTRAN (EUTRAN, also referred to as UTRAN-LTE or as EUTRA) is currently nearing completion within the 3GPP. As specified the DL access technique is OFDMA, and the UL access technique is SC-FDMA.

One specification of interest is 3GPP TS 36.300, V8.7.0 (2008-12), 3rd Generation Partnership Project; Technical Specification Group Radio Access Network; Evolved Universal Terrestrial Radio Access (EUTRA) and Evolved Universal Terrestrial Access Network (EUTRAN); Overall description; Stage 2 (Release 8). This system may be referred to for convenience as LTE Rel-8, or simply as Rel-8. In general, the set of specifications given generally as 3GPP TS 36.xyz (e.g., 36.211, 36.311, 36.312, etc.) may be seen as describing the Release 8 LTE system.

FIG. 1 reproduces FIG. 4.1 of 3GPP TS 36.300, and shows the overall architecture of the EUTRAN system. The EUTRAN system includes eNBs, providing the EUTRA user plane (PDCP/RLC/MAC/PHY) and control plane (RRC) protocol terminations towards the UE. The eNBs are interconnected with each other by means of an X2 interface. The eNBs are also connected by means of an S1 interface to an EPC, more specifically to a MME (Mobility Management Entity) by means of a S1 MME interface and to a Serving Gateway (S-GW) by means of a S1 interface. The S1 interface supports a many to many relationship between MMEs/Serving Gateways and eNBs.

3GPP is also currently studying dual-layer beamforming in a Release 9 LTE Work Item dedicated for the topic. This Work Item targets at specifying support of dual-layer MIMO transmission utilizing dedicated (e.g., demodulation) reference signals (DM-RS) for channel estimation at UE side and further data demodulation. These are equivalently referred to as dedicated RS (DRS) or UE-specific RS (URS).

In addition, at the same time 3GPP is studying also potential enhancements to LTE Release 8/9 in order to specify a new system called LTE-Advanced which fulfils the IMT-Advanced requirements set by the ITU-R. Reference can be made to 3GPP TR 36.814, V1.2.1 (2009-06), 3rd Generation Partnership Project; Technical Specification Group Radio Access Network; Further Advancements for E-UTRA Physical Layer Aspects (Release 9). Reference can also be made to 3GPP TR 36.913, V8.0.1 (2009-03), 3rd Generation Partnership Project; Technical Specification Group Radio Access Network; Requirements for Further Advancements for E-UTRA (LTE-Advanced) (Release 8). A goal of LTE-A is to provide significantly enhanced services by means of higher data rates and lower latency with reduced cost.

Topics that are included within the ongoing Work Item described above are, e.g., bandwidth extensions beyond 20 MHz, relays, cooperative MIMO, uplink multiple access schemes and MIMO enhancements such as advanced multi-user MIMO (MU-MIMO). Regarding downlink MIMO transmission, the target with LTE-A is to specify MIMO transmission up to 8×8, i.e., eight transmission antennas, whereas current Release 8 supports only up to 4×4. These high-order MIMO transmissions will also rely on dedicated (demodulation) reference signals for channel estimation at UE side. The dedicated reference signal (DRS) design in LTE-Advanced for eight layers will be a direct extension of the Release 9 DRS design for two layers.

LTE and thus also LTE-A support both FDD and TDD modes. TDD mode has a special subframe which has downlink part (DwPTS), followed by a guard period (GP) and an uplink part (UpPTS). This means that the downlink part size of the special subframe is different from the size of normal downlink subframes. This different size for the DwPTS relative to normal downlink subframes has potential implications with reference signals.

Typically, reference signals are designed such that they are scattered throughout the whole allocated physical resource block (PRB). This allows proper channel interpolation at the UE side when estimating the channel. Especially this is the case with dedicated reference signals that are present only in allocated PRBs (each PRB corresponding to a pre-defined region of the OFDM time-frequency grid)—hence the UE has to confine its channel estimation within the PRB and it is not typically possible to interpolate across PRBs/subframes. Another reason not to interpolate across PRBs is the assumption of per PRB spatial precoding, which can differ from one PRB to another (in other words channel interpolation across two consecutive PRBs in frequency would require the spatial precoding to be the same over these PRBs).

FIG. 2, including FIGS. 2A and 2B, shows examples of one dedicated reference signal approach envisioned for LTE-A, both in case of 1-4 (one to four) layers (FIG. 2A) and in case of 5-8 (five to eight) layers (FIG. 2B) in normal downlink subframes (each subframe consisting of several PRBs) used for downlink to the user equipment (UE). The vertical axis is frequency (e.g., different subcarriers) and the horizontal axis is time (e.g., OFDM symbols). The ovals indicate where the code of length 2/4 (two or four) is allocated.

The patterns are based on code division multiplexing (CDM) between different spatial layers where each spatial layer corresponds to a set of antenna weights at the eNB (i.e., spatial precoding), used to minimize interference between the layers and maximize power towards the desired user (e.g., UE). The difference between the two patterns is in the code length. In FIG. 2A, with 1-4 (one to four) layers, code length of two is utilized, where the code is used to spread symbols in two adjacent RS resource elements (REs) (adjacent REs have solid ovals around them). For example, one may utilize the two following Walsh Hadamard codes, [+1, +1] and [+1 −1], which will allow transmission of DM-RS for two spatial layers. There are six instances of this code within the PRB, as illustrated by the six solid ovals. That is, the symbols in the REs are spread using the Walsh Hadamard codes, and there are six instances of symbols that are spread using the spreading code. There are therefore 12 REs in total. Each dashed oval surrounds two additional REs, and there are six instances of this code within the PRB. Hence, an additional FDM component allows allocation of more DM-RS resources by an amount of 12 REs. These twelve additional DM-RS REs are code multiplexed between them in the same way as the first set of 12 REs reserved for DM-RS. Taking both the solid oval and dashed oval positions into account provides support for up to four spatial layers in total (i.e., two layers with two codes on REs in the solid ovals, and two layers with two codes on the REs in the dashed ovals).

In FIG. 2B, with five to eight spatial layers, code length of four is utilized, where up to four length-4 codes span over four RS REs in the time direction over the REs in solid ovals (the four RS REs are two in each solid oval, where a set of ovals are linked through a solid line), and up to four length-4 codes span over four RS REs in the time direction over the REs in dashed ovals (the four RS REs are two in each dashed oval, where a set of ovals are linked through a dashed line).

By contrast with the normal DL subframe shown in FIGS. 2A and 2B, in the TDD special subframe, there are fewer OFDM symbols available for downlink transmission. Hence, there are fewer possibilities to design the dedicated reference signal pattern, as GP (guard period) and UpPTS reserve some OFDM symbols from the subframe. Typical proposals to this problem are 1) shifting of the dedicated RS pattern according to DwPTS length (FIG. 3, including both FIGS. 3A and 3B) and/or 2) puncturing of dedicated RS with GP and UpPTS (FIG. 4).

Approach 1) is shown in FIG. 3, including both FIGS. 3A and 3B, which shows examples of shifting proposals for the special subframe for handling reference signal design in high-order MIMO. These are illustrated with two different DwPTS lengths, DwPTS length 11 (FIG. 3A) and DwPTS length 10 (FIG. 3B). The positions of the REs shift depending on the length of the DwPTS. For example, in FIG. 3A with a DwPTS length of 11, the DRS REs are in one set of positions, and in FIG. 3B, with a DwPTS length of 10, some of the DRS REs are now in different positions. Throughout this document, RS, DRS, DM-RS and URS are used as terms to indicate the same subject matter. It should be noted that the proposal in approach 1) supports both length-2 and length-4 codes.

Approach 1) has the problem that it effectively changes the DM-RS pattern, meaning that the channel estimation at the UE side will be different depending on the type of subframe (normal/special), and may even depend on the DwPTS length. This is not desirable from UE implementation perspective. Another problem is that when decreasing the length of DwPTS, there will be less room for actual data but the amount of RS stays the same with this approach. Hence, RS overhead in DwPTS will be very large, decreasing in turn the spectral efficiency.

Approach 2) is shown in FIG. 4, where the last three symbols 410 in this subframe simply puncture away the RS. Comparing this figure with FIG. 2A, it can be seen that last three symbols in FIG. 2A are now punctured away.

Approach 2) has a problem in that there are fewer DM-RS for channel estimation, hence fewer possibilities for the UE to do channel interpolation and thereby improve subsequent demodulation performance. More specifically, there is essentially no possibility for channel interpolation in time anymore once DM-RS REs are code multiplexed in the time direction, as previously described. Furthermore, a CDM implementation using this approach suffers greatly and in fact this approach becomes very problematic when trying to place the length-4 codes into the RS REs which are now fewer. In fact, higher order MIMO with greater than four layers becomes virtually impossible with this approach due to the small numbers of RS REs.

Further, in Release 8, which effectively uses approach 2), the dedicated RSs for one layer in DwPTS are defined such that GP and UpPTS simply puncture the rest of the subframe, and hence also the dedicated RS in that part of the subframe (i.e., approach 2 described above). As there are dedicated RS only for one layer in Release 8, any kind of multiplexing schemes between layers are not needed, hence the problem does not exist in Release 8.

To improve interpolation, it has been proposed related to the puncturing approach 2) to bundle the allocation in DwPTS with the preceding subframe such that the UE would have an allocation on the same PRBs in both subframes. Then, the UE may successfully interpolate over the subframes since DRS are present in both, assuming continuity of spatial precoding across the bundled sub-frames. This is illustrated in FIG. 5, which shows a punctured subframe 520 (as also shown in FIG. 4) bundled in time with a normal DL subframe 510 (as also shown in FIGS. 2A and 2B). However, this does not yet solve the code length issue highlighted above.

What are missing therefore are techniques to support longer spreading codes and hence higher order MIMO with punctured CDM-multiplexed RS.

### SUMMARY

In a first aspect, a method is disclosed that includes allocating length-2n spreading codes to reference signals contained on first and second groups of resource elements in a first physical resource block and to copies of the reference signals contained on a selected group from the first or second groups and a third group of resource elements in a second physical resource block. Each length-2n spreading code is determined using a first length-n spreading code allocated to the first group and a second length-n code allocated to the second group, or using whichever one of the first or second length-n spreading codes is allocated to the selected group and a third length-n spreading code allocated to the third group. The method includes spreading symbols according to the allocated length-2n spreading codes to determine spread symbols for the reference signals and their copies. The method additionally includes transmitting the reference signals and their copies on the corresponding first and second groups of resource elements in the first physical resource block and the third group of resource elements in the second physical resource block.

In another aspect, an apparatus is disclosed that includes at least one processor and at least one memory including computer program code. The at least one memory and the computer program code are configured to, with the at least one processor, cause the apparatus to perform at least the following: allocating length-2n spreading codes to reference signals contained on first and second groups of resource elements in a first physical resource block and to copies of the reference signals contained on a selected group from the first or second groups and a third group of resource elements in a second physical resource block. Each length-2n spreading code is determined using a first length-n spreading code allocated to the first group and a second length-n code allocated to the second group, or using whichever one of the first or second length-n spreading codes is allocated to the selected group and a third length-n spreading code allocated to the third group. The apparatus is also configured to perform spreading symbols according to the allocated length-2n spreading codes to determine spread symbols for the reference signals and their copies, and to perform transmitting the reference signals and their copies on the corresponding first and second groups of resource elements in the first physical resource block and the third group of resource elements in the second physical resource block.

In another exemplary aspect, a method is disclosed that includes receiving reference signals contained on first and second groups of resource elements in a first physical resource block and copies of the reference signals contained on a selected group from the first or second groups and a third group of resource elements in a second physical resource block. The reference signals are spread by length-2n spreading codes allocated such that each length-2n spreading code determined using a first length-n spreading code allocated to the first group and a second length-n code allocated to the second group, or using whichever one of the first or second length-n spreading codes is allocated to the selected group and a third length-n spreading code allocated to the third group. The method includes, using at least one selected length-2n spreading code of the allocated length-2n spreading codes, despreading symbols from one or both of the reference signals or the copies of the reference signals.

The method may further include performing channel estimations using one or both of despread symbols from the reference signals or despread symbols from the copies of the reference signals.

In another aspect, an apparatus includes at least one processor and at least one memory including computer program code. The at least one memory and the computer program code are configured to, with the at least one processor, cause the apparatus to perform at least the following: receiving reference signals contained on first and second groups of resource elements in a first physical resource block and copies of the reference signals contained on a selected group from the first or second groups and a third group of resource elements in a second physical resource block. The reference signals are spread by length-2n spreading codes allocated such that each length-2n spreading code determined using a first length-n spreading code allocated to the first group and a second length-n code allocated to the second group, or using whichever one of the first or second length-n spreading codes is allocated to the selected group and a third length-n spreading code allocated to the third group. The apparatus is configured to also perform, using at least one selected length-2n spreading code of the allocated length-2n spreading codes, despreading symbols from one or both of the reference signals or the copies of the reference signals.

### BRIEF DESCRIPTION OF THE DRAWINGS

For a more complete understanding of example embodiments of the present invention, reference is now made to the following descriptions taken in connection with the accompanying drawings.

FIG. 1 reproduces FIG. 4 of 3GPP TS 36.300, and shows the overall architecture of the EUTRAN system.

FIG. 2, including both FIGS. 2A and 2B, shows exemplary dedicated RS patterns in normal downlink subframes (each subframe embodied in one PRB), both in case of 1-4 layers (FIG. 2A) and in case of 5-8 layers (FIG. 2B), where the vertical axis is frequency (e.g., different subcarriers) and the horizontal axis is time (e.g., OFDM symbols), and where the ovals indicate where the code of length 2/4 (two or four) is allocated.

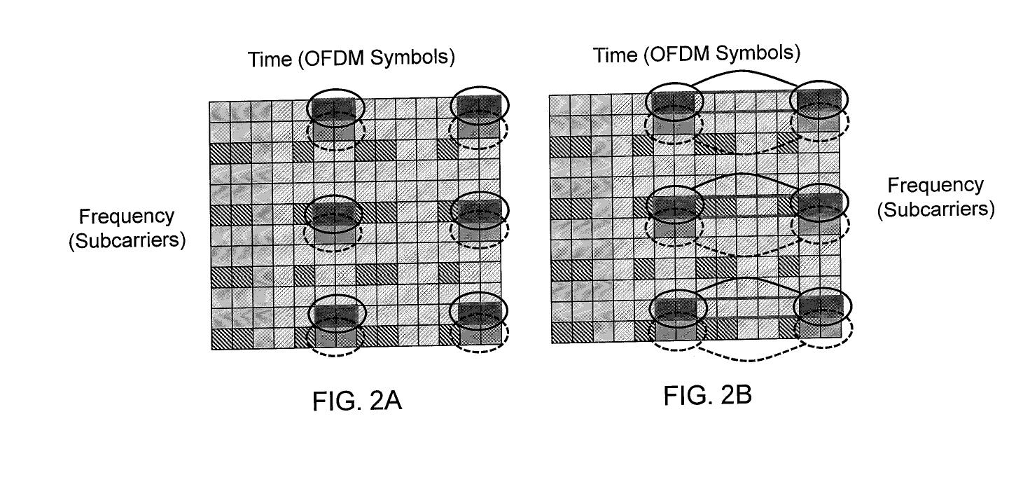

FIG. 3, including both FIGS. 3A and 3B, shows examples of shifting proposals for the special subframe for handling reference signal design in high-order MIMO, illustrated with two different DwPTS lengths, DwPTS length 11 (FIG. 3A) and DwPTS length 10 (FIG. 3B).

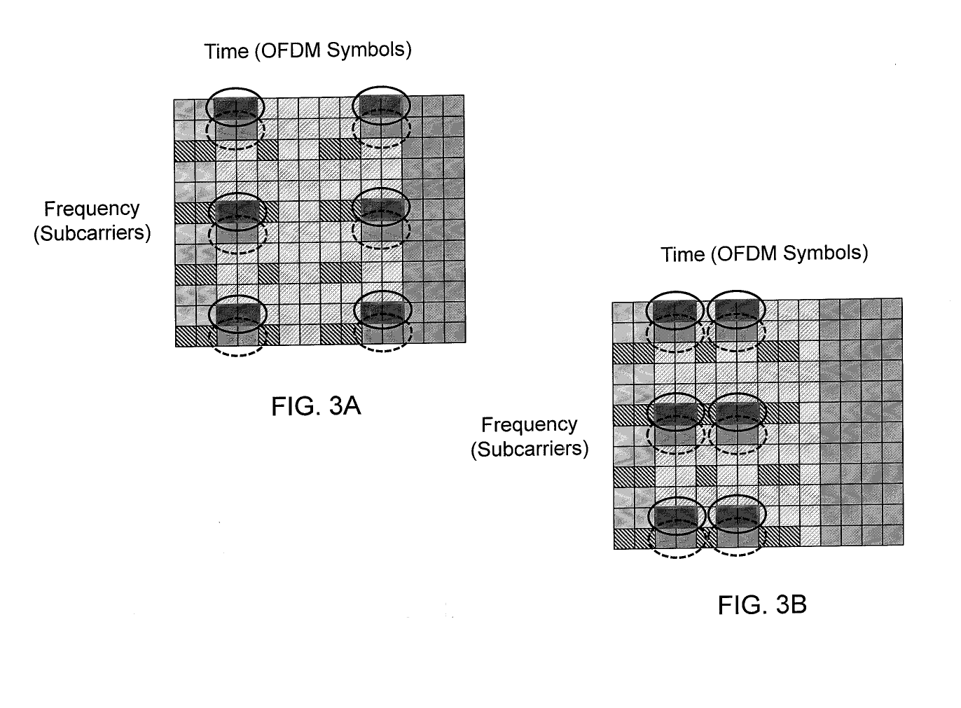

FIG. 4 shows an example of a puncturing proposal for the special subframe for handling reference signal design in high-order MIMO, where the last three symbols simply puncture the RS away (compare with FIG. 2A).

FIG. 5 shows an example of a proposal of bundled subframes (a normal subframe bundled in time with a special subframe) for handling reference signal design in high-order MIMO, and particularly to help with a channel interpolation issue related to a puncturing approach such as that shown in FIG. 4.

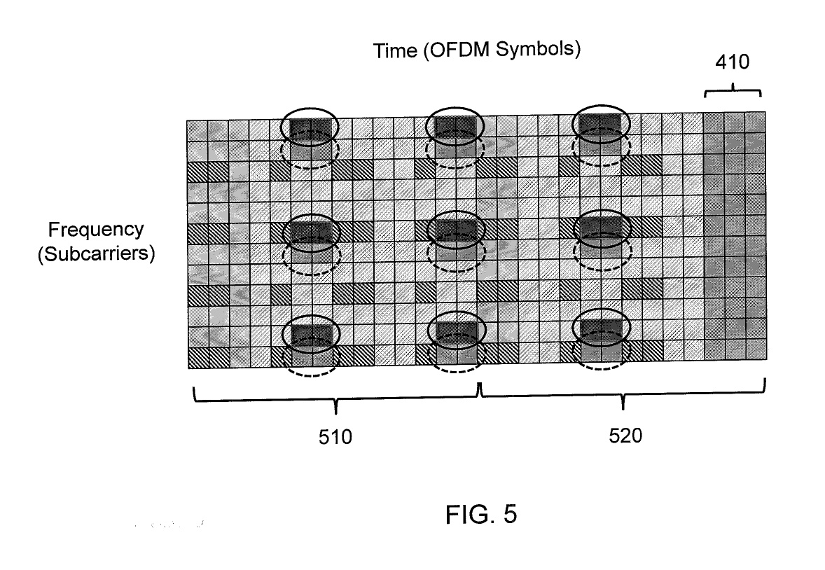

FIG. 6A shows a simplified block diagram of various electronic devices that are suitable for use in practicing the exemplary embodiments of this invention.

FIG. 6B shows a more particularized block diagram of a user equipment such as that shown at FIG. 6A.

FIG. 7 shows an orthogonal variable spreading factor code tree structure suitable for use with certain exemplary embodiments of the present invention.

FIG. 8 contains illustrations of code allocation in bundled PRBs (each part of a subframe) and the related despreading operations at the UE side before channel estimation and interpolation.

FIG. 9 is a logic flow diagram illustrating actions taken by a network node (typically an eNB) in accordance with an exemplary embodiment of invention.

FIG. 10 is a logic flow diagram illustrating actions taken by a UE in accordance with an exemplary embodiment of invention.

FIG. 11 is a table illustrating possible lengths of DwPTS, GP, and UpPTS for the special subframe.

### DETAILED DESCRIPTION OF THE DRAWINGS

An aspect of this invention addresses dedicated reference signal design for the special subframe and DwPTS in TDD mode in the case of high-order MIMO (e.g., more than four spatial streams or in other words a transmission rank above four).

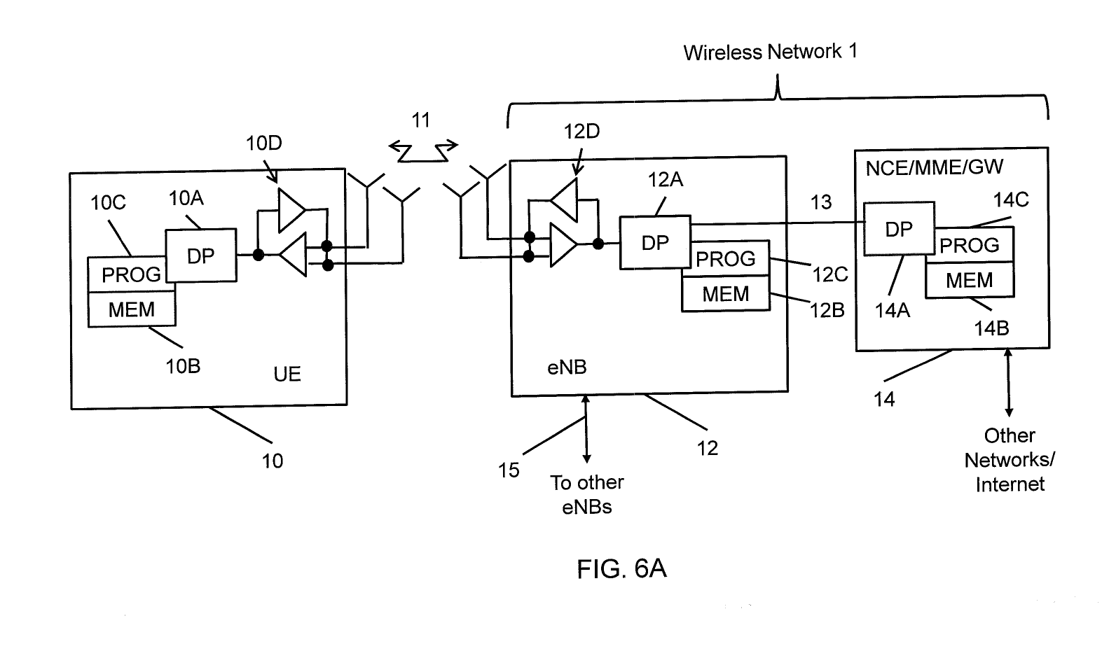

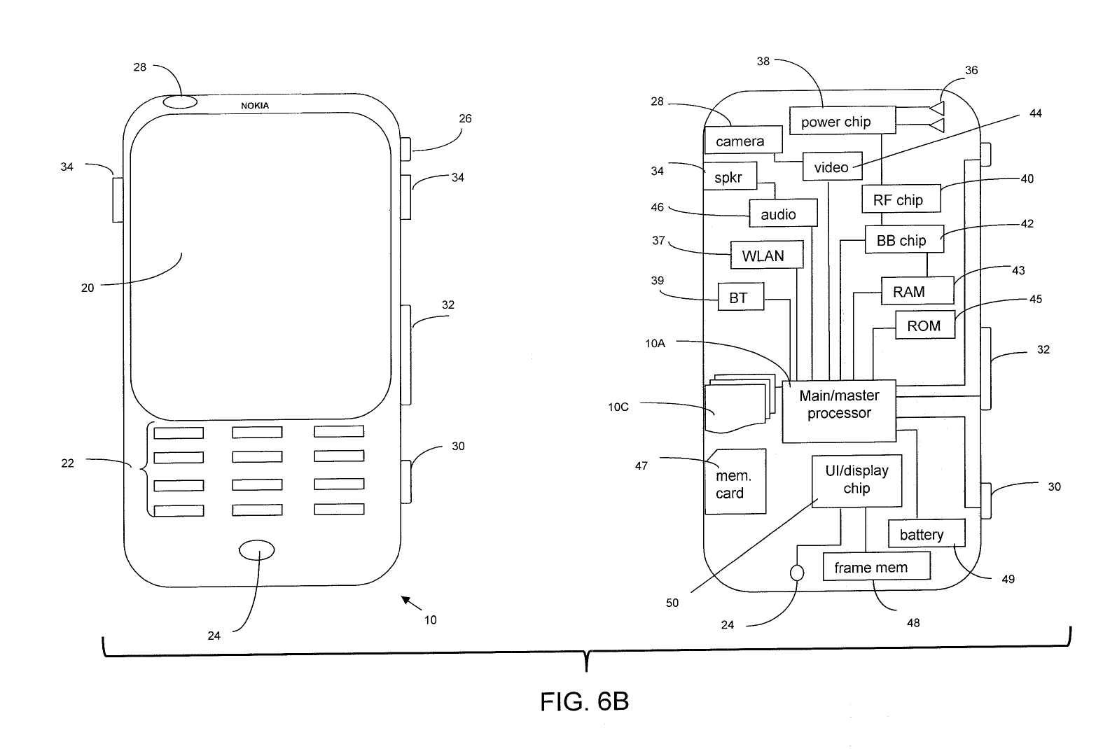

Before proceeding with additional description of the present invention, attention is directed now to FIGS. 6A-B, where are described exemplary and non-limiting apparatus/devices which may be used to practice and/or to embody various aspects of the invention.

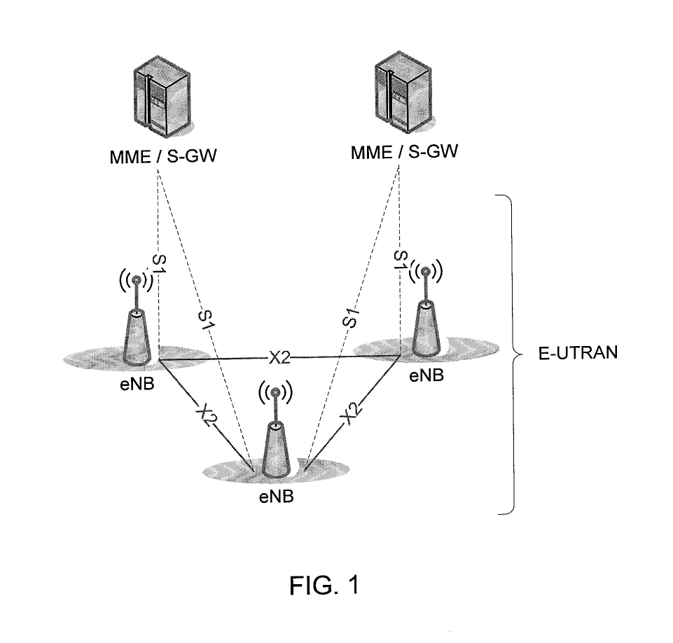

In FIG. 6A a wireless network 1 is adapted for communication over a wireless link 11 with an apparatus, such as a mobile communication device which may be referred to as a UE 10, via a network access node, such as a Node B (base station), and more specifically an eNB 12. It will be appreciated that the functions of the described eNB 12 may be conducted by a relay node, such as a type 1 relay in LTE-A which has control over its own cell and which appears to the UE 10 as the eNB 12. The network 1 may include a network control element (NCE) 14 that may include the MME/S GW functionality shown in FIG. 1, and which provides connectivity with another broader network, such as a telephone network and/or a data communications network (e.g., the internet). The UE 10 includes a controller, such as a computer or a data processor (DP) 10A, a computer-readable storage medium embodied as a memory (MEM) 10B that stores a program of computer instructions (PROG) 10C, and a suitable radio frequency (RF) transceiver 10D for bidirectional wireless communications with the eNB 12 via one or more antennas. The eNB 12 also includes a controller, such as a computer or a data processor (DP) 16A, a computer-readable memory medium embodied as a memory (MEM) 16B that stores a program of computer instructions (PROG) 12C, and a suitable RF transceiver 12D for communication with the UE 10 via one or more antennas. The eNB 12 is coupled via a data/control path 13 to the NCE 14. The path 13 may be implemented as the S1 interface shown in FIG. 1. The eNB 12 may also be coupled to another eNB via data/control path 15, which may be implemented as the X2 interface shown in FIG. 1.

At least one of the PROGs 10C and 12C is assumed to include program instructions that, when executed by the associated DP, enable the device to operate in accordance with the exemplary embodiments of this invention, as will be discussed below in greater detail.

That is, the exemplary embodiments of this invention may be implemented at least in part by computer software executable by the DP 10A of the UE 10 and/or by the DP 16A of the eNB 12, or by hardware, or by a combination of software and hardware (and firmware).

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 16B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 16A may be of any type suitable to the local technical environment, and may include one or more of general purpose computers, special purpose computers, microprocessors, digital signal processors (DSPs) and processors based on a multicore processor architecture, as non-limiting examples.

FIG. 6B illustrates further detail of an exemplary UE in both plan view (left) and sectional view (right), and the invention may be embodied in one or some combination of those more function-specific components. At FIG. 6B the UE 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user. The exemplary UE 10 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 32 which may alternatively function as a volume adjustment for the speaker(s) 34 when the camera 28 is not in an active mode.

Within the sectional view of FIG. 6B are seen multiple transmit/receive antennas 36 that are typically used for cellular communication. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and fmally decoded. Similar processing occurs in reverse for signals generated in the apparatus 10 and transmitted from it.

An exemplary UE 10 may also include a camera 28 and image/video processor 44, a separate audio processor 46 for outputting to speakers 34 and for processing inputs received at the microphone 24. The graphical display interface 20 is refreshed from a frame memory 48 as controlled by a user interface chip 50 which may process signals to and from the display interface 20 and/or additionally process user inputs from the keypad 22 and elsewhere. Certain embodiments of the UE 10 may also include one or more secondary radios such as a wireless local area network radio WLAN 37 and a BLUETOOTH radio 39, which may incorporate an antenna on-chip or be coupled to an off-chip antenna. Throughout the apparatus are various memories such as random access memory RAM 43, read only memory ROM 45, and in some embodiments removable memory such as the illustrated memory card 47 on which the various programs 10C are stored. All of these components within the UE 10 are normally powered by a portable power supply such as a battery 49.

The aforesaid processors 10E/12E, 38, 40, 42, 44, 46, 50, if embodied as separate entities in a UE 10 or eNB 12, may operate in a slave relationship to the main processor 10A, 16A, which may then be in a master relationship to them. Any or all of these various processors of FIG. 6B access one or more of the various memories, which may be on-chip with the processor or separate therefrom. Similar function-specific components that are directed toward communications over a network broader than a piconet (e.g., components 36, 38, 40, 42-45 and 47) may also be disposed in exemplary embodiments of the access node 12, which may have an array of tower-mounted antennas rather than the two shown at FIG. 6B.

Note that the various chips (e.g., 10E/12E, 38, 40, 42, etc.) that were described above may be combined into a fewer number than described and, in a most compact case, may all be embodied physically within a single chip.

In exemplary embodiments, spreading code allocation techniques are disclosed that overcome the issues described above with CDM DM-RS multiplexing and punctured DM-RS patterns, and simultaneously allow even higher-order MIMO operation with the punctured RS pattern.

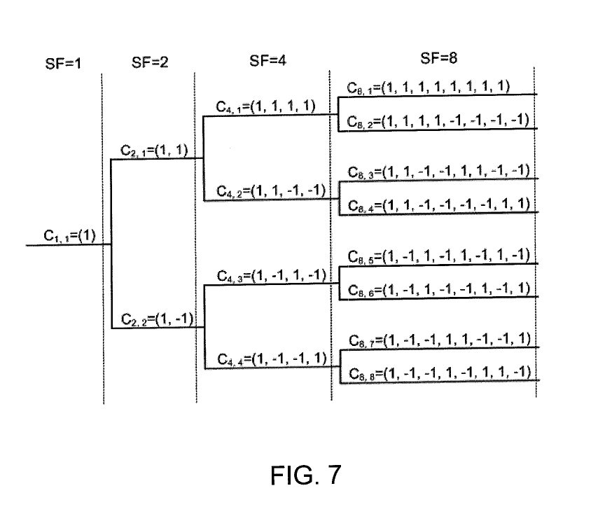

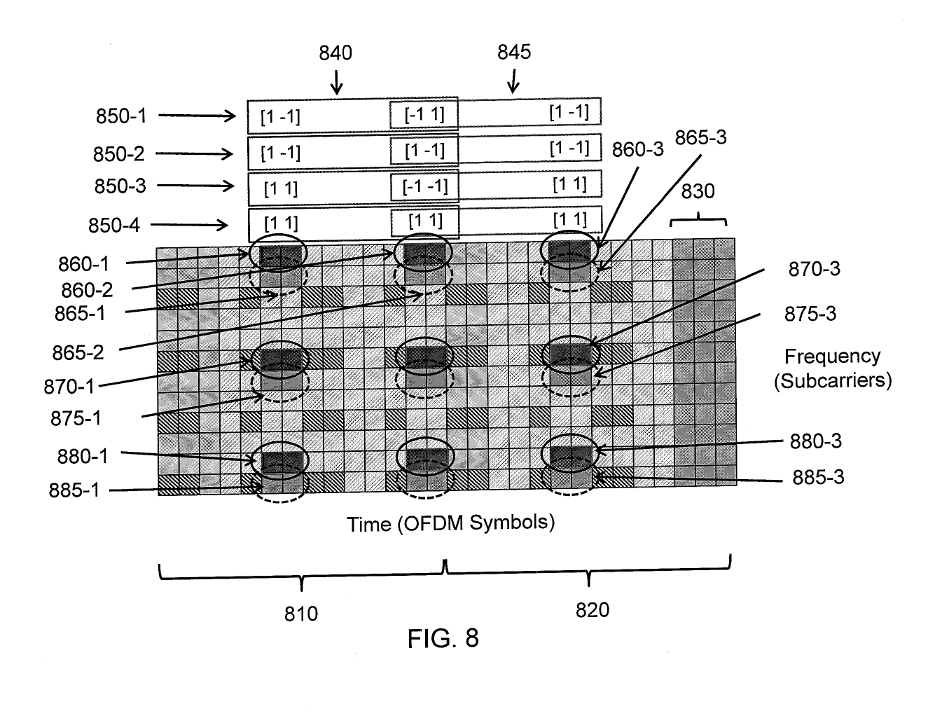

One exemplary embodiment of these techniques assumes that bundled subframes (or bundled PRBs from subframes) are used to help in channel interpolation at the UE side. Turning to FIGS. 7 and 8, FIG. 7 shows an orthogonal variable spreading factor code tree structure suitable for use with certain exemplary embodiments of the present invention, while FIG. 8 contains illustrations of code allocation in bundled subframes and the related despreading operations at the UE side before channel estimation and interpolation.

In FIG. 8, the bundled subframes are the normal DL subframe 810 and the special, punctured subframe 820 that contains the DwPTS and a set 830 of punctured symbols. There are three groups 860-1, 860-2, and 860-3 of resource elements, each of which contains two resource elements, and each resource element can contain in this example a single symbol. To enable and improve interpolation, these three groups 860 of resource elements are repeated in groups 870-1 through 870-3 and 880-1 through 880-3 of resource elements.

Group 860-1 and group 860-2 of resource elements are in the normal DL subframe 810, and a third group 860-3 of resource elements is in the special subframe 820. The exemplary embodiment shown in FIG. 8 addresses how to enable dedicated reference signals in the groups 860 of resource elements for high-order MIMO. In other words, given the groups 860 of resource elements, an aspect of this invention teaches how to enable multiple spatial layers 850 for the reference signals (RSs) on the resource elements (REs). It should be noted that in SU-MIMO, all spatial layers 850 are allocated to a single UE (the total number of spatial layers is equal to the transmission rank). In MU-MIMO, spatial layers are allocated among multiple UEs, where each UE may be assigned and receive one or more spatial layers 850.

One exemplary technique to enable this is to utilize spreading codes with a hierarchical structure, as shown in FIG. 7, such that length-4 spreading codes are constructed from two length-2 spreading codes. The length-2 spreading codes are allocated to the RS REs such that the normal subframe 810 is allocated two instances of length-2 spreading code, i.e., one full length-4 spreading code overall. Therefore, each group 860-1 and 860-2 (one RS 840) is allocated a length-2 spreading code, and these length-2 spreading codes taken together create a length-4 spreading code. This enables having four different orthogonal spreading codes and thus four spatial layers 850-1, 850-2, 850-3, and 850-4 for which the UEs may estimate the channel, nearly in an interference-free manner. In terms of the orthogonal spreading codes, the group 860-1 of REs is allocated the first two symbols from the spreading codes C_{4,4}, C_{4,3}, C_{4,2}, and C_{4,1} for spatial layers 850-1, 850-2, 850-3, and 850-4, respectively. The group 860-2 of REs is allocated the second two symbols from the spreading codes C_{4,4}, C_{4,3}, C_{4,2}, and C_{4,1} for spatial layers 850-1, 850-2, 850-3, and 850-4, respectively. Thus, the allocation for both groups 860-1 and 860-2 together would be the spreading codes C_{4,4,} C_{4,3}, C_{4,2}, and C_{4,1} for spatial layers 850-1, 850-2, 850-3, and 850-4, respectively, and are allocated to and will be transmitted as one RS.

Additionally, the group 860-3 of REs is allocated (in this example) the first two symbols from the spreading codes C_{4,4}, C_{4,3}, C_{4,2}, and C_{4,1} for spatial layers 850-1, 850-2, 850-3, and 850-4, respectively. Thus, the allocation for groups 860-2 (from the normal subframe 810) and 860-3 (from the special subframe 820) together would be the spreading codes C_{4,4}, C_{4,3}, C_{4,2}, and C_{4,1} for spatial layers 850-1, 850-2, 850-3, and 850-4, respectively, with the modification that the first and second set of length-2 spreading codes in the length-4 spreading codes are interchanged. The groups 860-2 and 860-3 therefore are allocated to and will be transmitted as an RS 845, which is a copy of the RS 840 contained in groups 860-1 and 860-2. From the perspective of the UE, this interchanging of the length-2 codes makes little difference to despreading and subsequent use of the REs.

From another perspective, the special subframe 820 taken alone misses one instance of the length-2 spreading codes, which would be used to constitute the overall length-4 spreading code. This missing instance can be replaced by the corresponding one from the preceding subframe (e.g., from group 860-2 of REs) during the length-4 despreading operation. One may think of this despreading operation as “wrapping around”. Since despreading essentially amounts to a weighted sum, the order in which one sums the elements does not matter. Therefore, the UE can despread an RS 840 and the copy RS 845, and both despreading operations should yield the same result. This presumes the wireless channel does not vary much between the two subframes, which anyway is an assumption when one uses length-4 spreading codes in the time direction.

Note that to enable eight spatial layers 850 (only four of which are shown in FIG. 8 and are assigned to the groups 860-1, 860-2 and 860-3 of REs), the FDM component of the groups 865-1, 865-2, and 865-3 of REs (and corresponding RSs and their copies) may be used. These REs (and RSs and their copies) are also repeated as groups 875-1 through 875-3 and 885-1 through 885-3 of REs. Hence, in the normal subframe 810, the UE would perform despreading (as a first despreading of the RS 840) with the length-4 spread code as usual to estimate a channel for one of the spatial layers 850.

As described above, the special subframe 820 only contains one instance of the length-2 spreading code. However, with the assumed subframe bundling as shown in FIG. 8 and the given code structure, the UE may now combine one of the length-2 spreading codes (in the example of FIG. 8, the length-2 code allocated to group 860-2) allocated in the first subframe 810 with the length-2 spreading code allocated to group 860-3 in the special subframe 820 to get another full length-4 spreading code. Hence, the UE may then again perform despreading (a second despreading of RS 845, which is a copy of the RS 840) with this length-4 code.

To summarize, in an exemplary embodiment, the UE may perform a first despreading using the length-4 code (in RS 840) in the first normal subframe as usual, and then perform second despreading (using RS 845) by taking the first length-2 part of the length-4 spreading code from the first normal subframe, and the second length-2 part of the length-4 spreading code from the punctured DwPTS part of the special subframe.

The UE would despread the RS 840, 845 of the spatial layers assigned to it as illustrated in FIG. 8. Hence, the UE will receive two channel samples (one for each RS 840, 845) for channel interpolation in the time domain. Note that this is the same as what the UE would receive in two normal subframes without bundling of the subframes. After despreading, the UE may estimate the channel with any kind of channel estimation filter, e.g. the Wiener filter or any other interpolator. The length-4 spreading codes are allocated to spatial layers such that there is always exactly one code per layer. As described above, eight spatial layers are enabled by having an FDM component (i.e., groups 865-1, 865-2 of REs for an RS and groups 865-2 and 865-3 for a copy of the RS) in addition to the four codes in the groups 860-1, 860-2, and 860-3 of REs.

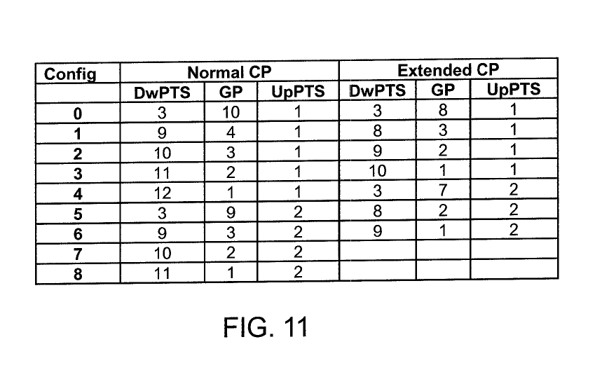

As for the special subframe 820, the DwPTS, GP, and UpPTS have possible exemplary lengths shown in the table in FIG. 11. It is noted that a similar table can be found in TS 36.211, section 4.2, but the table in that TS has lengths given as multiples of sample period. The table in FIG. 11 has lengths given in OFDM symbols for a PRB.

It is noted that the invention does not need to be limited to time-domain bundling of subframes and their PRBs, but could also be used if two PRBs are bundled together in frequency-domain bundling. However, exposing the CDM code to frequency selectivity of the channel makes this approach potentially less attractive but still possible. Note for a simple UE implementation, the spreading codes have the hierarchical structure described above. However, other spreading codes will work as well as long as one of the length-2 parts in the RS REs of the first subframe and the length-2 part in the RS REs of the DwPTS section are different and form a length-4 code. It is further noted that the invention is also not limited to length-4 spreading codes made from length-2 spreading codes, and instead can be generalized to length-2n spreading codes made from length-n spreading codes.

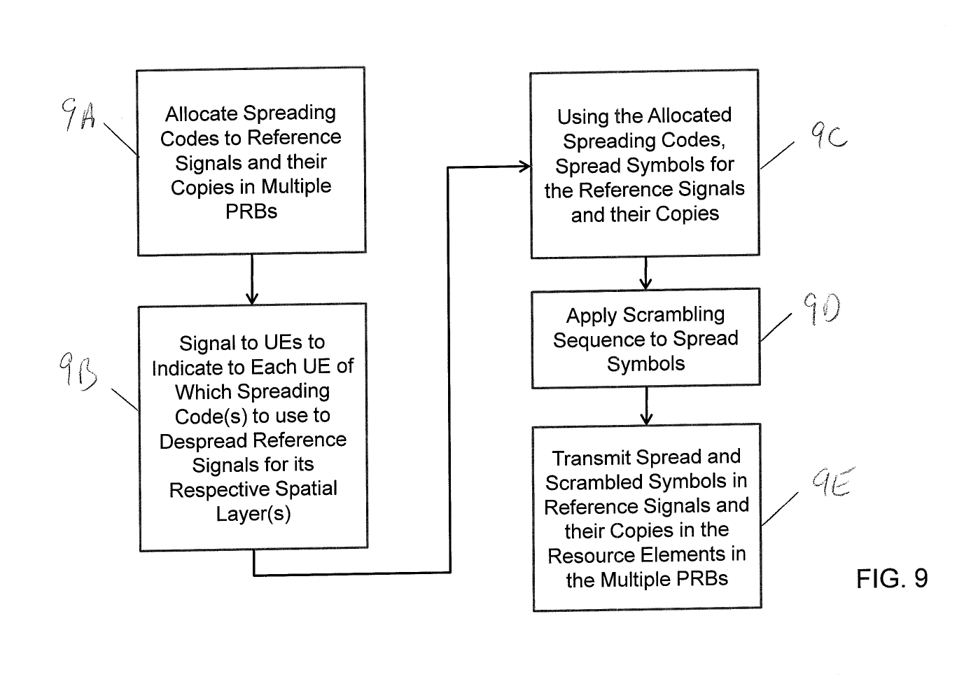

Turning now to FIG. 9 with appropriate reference to other figures, this figure is a logic flow diagram illustrating actions performed by a network node (typically an eNB 12) in accordance with an exemplary embodiment of invention. The flow diagram begins in Block 9A, when a network node allocates spreading codes to multiple spatial layers 850 and to RSs 840 and their copies 845 used for the REs in multiple subframes 810, 820. It is noted that the RSs have the same spatial precoding (i.e., the RSs are transmitted with the same antenna weights) as the data layer/stream they are associated with. Each spatial layer 850 is typically assigned to one or multiple UEs. The allocation of spreading codes to RSs 840 and corresponding REs and the copies 845 of the RSs is discussed above in reference to FIGS. 7 and 8.

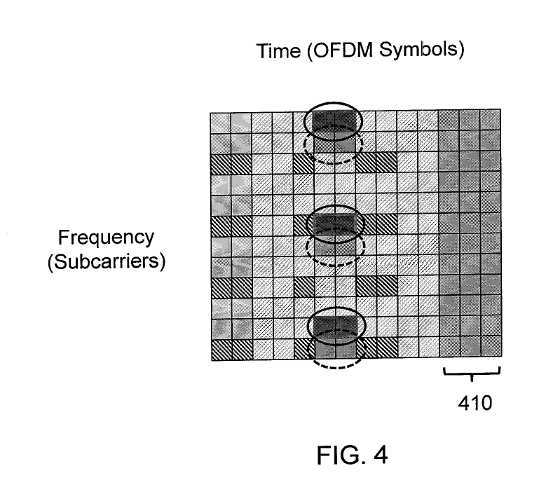

In Block 9B, the network node signals the UEs to indicate to each UE which spreading code(s) to use to despread REs for the user equipment's respective spatial layer(s). For example, the network node could send to a UE an index into the length-4 spreading codes C_{4,1}, C_{4,2}, C_{4,3}, and C_{4,4} shown in FIG. 4 (or an index into length-2n codes). It should be noted that Block 9B is optional, as the spreading code assigned to the UE could be implicit from, for example, rank indication, i.e., certain codes are tied to certain rank.

In Block 9C, the network node, using the allocated spreading codes as shown above in reference to FIGS. 7 and 8, then spreads symbols that correspond to the RSs and their copies (and to associated groups of REs). As an example, if Qk is a symbol to be placed into the REs, and the length-4 code is the code shown in the RS 840 of the spatial layer 850-1, the spread symbols would be +Qk, −Qk, −Qk, and +Qk, where +Qk, −Qk would be placed (in Block 9E) into group 860-1, −Qk, +Qk would be placed into group 860-2, and +Qk, −Qk would be placed into group 860-3. It is noted that the RS 845 (in groups 860-2 and 860-3) contains a copy of the spread symbols in the RS 840 (in groups 860-1 and 860-2).

In block 9D, a scrambling sequence is applied to the spread symbols. The orthogonal code which separates the spatial layers (in the example above, real Walsh Hadamard code) is symbol-wise multiplied with a scrambling sequence. The scrambling sequence is typically obtained from a Gold sequence generator initialized with a series of bits. Note that the scrambling sequence should be common to all spatial layers involved in the transmission over these specific time-frequency resources (targeted to a given UE or multiple UEs). If this is not the case, the CDM (in an example, Walsh Hadamard) code orthogonality will fail and one will lose its benefits (i.e., orthogonalizing the DM-RS associated to different spatial layers).

In Block 9E, the RSs 840 and their copies 845 are transmitted by transmitting the spread and scrambled symbols in their corresponding REs 860-1, 860-2 and 860-3 in the multiple subframes, as shown in FIG. 8 and described previously. It should be noted that the spreading and scrambling can occur at RE locations reserved for DM-RS, such as what would occur when symbols of a subframe are stored in memory and manipulated prior to transmission. It should also be noted that each of the subframes 810, 820 of FIG. 8 is each associated with a PRB, and these PRBs happen to be bundled using time-domain bundling. The PRBs may also be bundled in frequency-domain bundling.

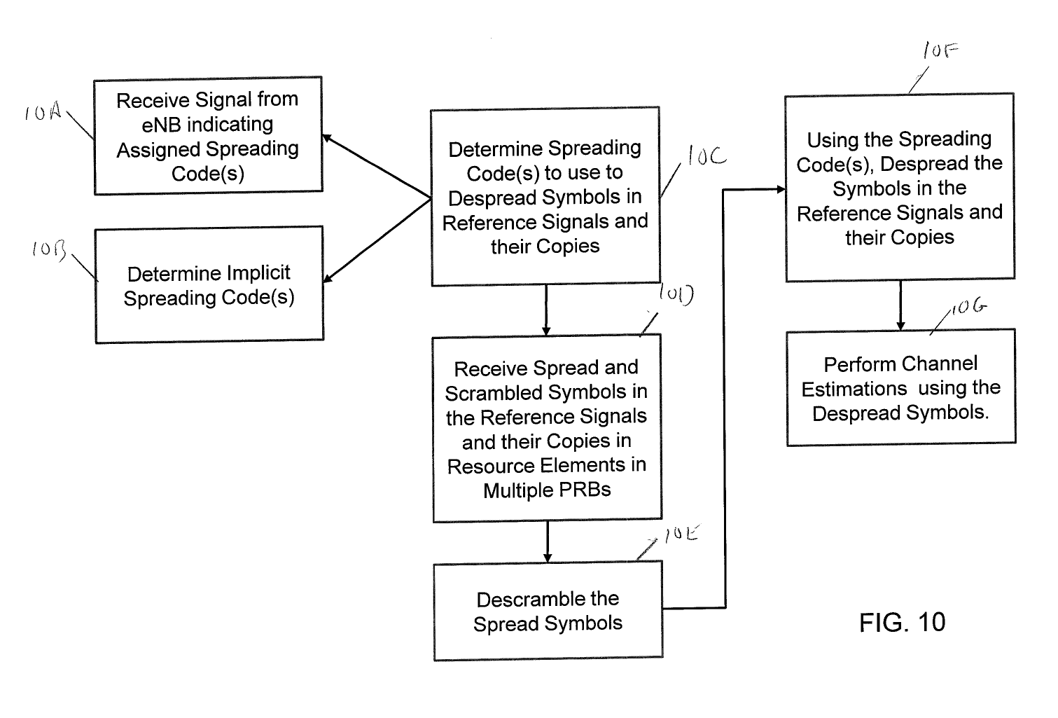

Turning now to FIG. 10 with appropriate reference to other figures, this figure is a logic flow diagram illustrating actions performed by a UE (e.g., UE 10 of FIGS. 6A and 6B) in accordance with an exemplary embodiment of invention. The UE in Block 10C determines spreading code(s) to use to despread symbols in the RSs 840 and their copies 845 (and associated groups 860, 865, 870, 875, 880, and 885 of REs) for respective spatial layer(s) 850 assigned to the UE. In one example, the UE receives a signal from a network node (eNB 12 in the example of FIG. 10) indicating the assigned spreading code(s) (Block 10A). As another example, the UE can determine implicit spreading code(s) to use, perhaps based on rank or through other techniques (Block 10B).

In Block 10D, the UE receives spread and scrambled symbols in corresponding REs in multiple subframes 810, 820. In other words, in FIG. 8, the UE receives the groups 860-1, 860-2 corresponding to RS 840 in subframe 810 and group 860-3 in subframe 820 (where group 860-2 and 860-3 corresponding to an RS 845, which is a copy of RS 840). Note that the UE also receives, in an exemplary embodiment, groups 865-1, 865-2, 870-1, 870-2, 875-1, 875-2, 880-1, 880-2, 885-1, and 885-2 of REs in subframe 810 and groups 865-3, 870-3, 875-3, 880-3, and 885-3 of REs in subframe 820, and these symbols are likewise operated on as described in FIGS. 10, 8, and 7. For ease of reference, only operations on three groups 860 of REs are discussed herein.

In Block 10E, the UE descrambles the spread symbols. The UE will therefore descramble DM-RS 840, 845, and this will reveal the orthogonal code separating the spatial layers (that is, the symbols spread by the orthogonal code). In Block 10F, the UE despreads the symbols in the REs using the determined spreading code (e.g., Walsh Hadamard) separating the spatial layers to reveal the channel at this time-frequency location. Note that multiple despreadings (e.g., of RS 840, 845) will typically be performed by the UE. In Block 10G, the UE proceeds with channel estimation (e.g., interpolation) using despread symbols from the RS 840, despread symbols from RS 845, or both.

The various blocks shown in FIGS. 9 and 10 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the LTE-A system, it should be appreciated that the exemplary embodiments of this invention are not limited for use with only this one particular type of communication system, and that they may be used to advantage in other communication systems which use multiple PRBs and need to enable spatial layers for symbols in the subframes.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
allocating length-2n spreading codes to reference signals contained on first and second groups of resource elements in a first physical resource block and to copies of the reference signals contained on a selected group from the first or second groups and a third group of resource elements in a second physical resource block, each length-2n spreading code determined using a first length-n spreading code allocated to the first group and a second length-n code allocated to the second group, or using whichever one of the first or second length-n spreading codes is allocated to the selected group and a third length-n spreading code allocated to the third group;
spreading symbols according to the allocated length-2n spreading codes to determine spread symbols for the reference signals and their copies; and
transmitting the reference signals and their copies on the corresponding first and second groups of resource elements in the first physical resource block and the third group of resource elements in the second physical resource block.

2. The method of claim 1, wherein the first physical resource block is time-domain bundled with and adjacent in time to the second physical resource block.

3. The method of claim 2, wherein the selected group is the second group, and transmitting further comprises transmitting the first group of resource elements at a first time, transmitting the second group of resource elements at a second time, and transmitting the third group of resource elements at a third time, wherein the first time is earliest and the third time is latest.

4. The method of claim 1, wherein the first and second physical resource blocks are frequency-domain bundled together.

5. The method of claim 1, wherein transmitting further comprises transmitting the reference signals and their copies in repeated instances at selected additional first and second groups of resource elements in the first physical resource block and at selected third groups of resource elements second physical resource block.

6. The method of claim 1, wherein the length-n and length-2n spreading codes are determined from a hierarchical code structure, such that the length-2n spreading codes are determined from length-n codes in the hierarchical code structure.

7. The method of claim 1, wherein the first subframe comprises a normal downlink subframe between a base station and a user equipment, and the second subframe comprises a special subframe comprising at least a downlink part and a punctured part, and wherein the third group of resource elements are contained within the downlink part of the special subframe.

8. The method of claim 1, wherein the first and second length-n spreading codes have respective first and second values, and whichever one of the first or second length-n spreading codes is allocated to the selected group and the third length-n spreading code have respective second and first values.

9. (canceled)

10. (canceled)

11. The method of claim 1, performed by computer program product comprising a computer-readable medium bearing computer program code embodied therein for use with a computer.

12. An apparatus, comprising:
at least one processor; and
at least one memory including computer program code,
the at least one memory and the computer program code configured to, with the at least one processor, cause the apparatus to perform at least the following:
allocating length-2n spreading codes to reference signals contained on first and second groups of resource elements in a first physical resource block and to copies of the reference signals contained on a selected group from the first or second groups and a third group of resource elements in a second physical resource block, each length-2n spreading code determined using a first length-n spreading code allocated to the first group and a second length-n code allocated to the second group, or using whichever one of the first or second length-n spreading codes is allocated to the selected group and a third length-n spreading code allocated to the third group;
spreading symbols according to the allocated length-2n spreading codes to determine spread symbols for the reference signals and their copies; and
transmitting the reference signals and their copies on the corresponding first and second groups of resource elements in the first physical resource block and the third group of resource elements in the second physical resource block.

13. The apparatus of claim 12, wherein the first subframe comprises a normal downlink subframe between a base station and a user equipment, and the second subframe comprises a special subframe comprising at least a downlink part and a punctured part, and wherein the third group of resource elements are contained within the downlink part of the special subframe.

14. The apparatus of claim 12, wherein the length-n and length-2n spreading codes are determined from a hierarchical code structure, such that the length-2n spreading codes are determined from length-n codes in the hierarchical code structure.

15. A method, comprising:
receiving reference signals contained on first and second groups of resource elements in a first physical resource block and copies of the reference signals contained on a selected group from the first or second groups and a third group of resource elements in a second physical resource block, wherein the reference signals are spread by length-2n spreading codes allocated such that each length-2n spreading code determined using a first length-n spreading code allocated to the first group and a second length-n code allocated to the second group, or using whichever one of the first or second length-n spreading codes is allocated to the selected group and a third length-n spreading code allocated to the third group; and
using at least one selected length-2n spreading code of the allocated length-2n spreading codes, despreading symbols from one or both of the reference signals or the copies of the reference signals.

16. The method of claim 15, further comprising performing channel estimations using one or both of despread symbols from the reference signals or despread symbols from the copies of the reference signals.

17. The method of claim 15, wherein either the first physical resource block is time-domain bundled with the second physical resource block or the first and second physical resource blocks are frequency-domain bundled together.

18. The method of claim 15, further comprising either receiving signaling comprising an indication of the at least one selected length-2n spreading code or determining the at least one selected length-2n spreading code through rank.

19. (canceled)

20. The method of claim 15, wherein the length-n and length-2n spreading codes are determined from a hierarchical code structure, such that the length-2n spreading codes are determined from length-n codes in the hierarchical code structure.

21. The method of claim 15, wherein the first subframe comprises a normal downlink subframe between a base station and a user equipment, and the second subframe comprises a special subframe comprising at least a downlink part and a punctured part, and wherein the third group of resource elements are contained within the downlink part of the special subframe.

22. The method of claim 15, wherein the first and second length-n spreading codes have respective first and second values, and whichever one of the first or second length-n spreading codes is allocated to the selected group and the third length-n spreading code have respective second and first values.

23. The method claim 15, wherein receiving further comprises receiving additional reference signals contained on first and second groups of additional resource elements in the first physical resource block and receiving copies of the additional reference signals contained on a selected group from the first or second groups of additional resource elements and a third group of additional resource elements in the second physical resource block, and despreading further comprises, using at least one selected length-2n spreading code of the allocated length-2n spreading codes, despreading symbols from one or both of the additional reference signals or the additional copies of the reference signals.

24. The method of claim 15, further comprising, prior to transmitting, applying a scrambling sequence to the spread symbols for the reference signals and their copies.

25. The method of claim 15, performed by computer program product comprising a computer-readable medium bearing computer program code embodied therein for use with a computer.

26. An apparatus, comprising:
at least one processor; and
at least one memory including computer program code, the at least one memory and the computer program code configured to, with the at least one processor, cause the apparatus to perform at least the following:
receiving reference signals contained on first and second groups of resource elements in a first physical resource block and copies of the reference signals contained on a selected group from the first or second groups and a third group of resource elements in a second physical resource block, wherein the reference signals are spread by length-2n spreading codes allocated such that each length-2n spreading code determined using a first length-n spreading code allocated to the first group and a second length-n code allocated to the second group, or using whichever one of the first or second length-n spreading codes is allocated to the selected group and a third length-n spreading code allocated to the third group; and
using at least one selected length-2n spreading code of the allocated length-2n spreading codes, despreading symbols from one or both of the reference signals or the copies of the reference signals.

27. (canceled)

28. (canceled)
